(19) United States
(12) Patent Application Publication
(10) Pub. No.: US 2001/0031070 A1
(43) Pub. Date: Oct. 18, 2001

(54) Global motion estimation

(76) Inventors: Christopher Wei, Taipei (TW); Tzu-Hung Cheng, Taipei Neihu (TW); Jyh-Kuen Horng, Taipei (TW)

Correspondence Address: U.S. Philips Corporation, 580 White Plains Road, Tarrytown, NY, 10591, US

(21) Appl. No.: 09/817,972

(22) Filed: Mar. 27, 2001

(30) Foreign Application Priority Data
Mar. 30, 2000 (EP) 00201153.4

(51) Int. Cl. G06T 7/20

(52) U.S. Cl. 382/107

(57) ABSTRACT

In a method of estimating (BME) a global motion vector (GMV), only a central part (C) of an electronic image (EI) is used, which central part (C) is substantially smaller than the electronic image (EI).

The invention relates to a method and device for global motion estimation.

The earlier non-prepublished EP application No.: 99202532.0-2202, filed on Feb. 8. 1999 (attorneys' docket PHN 17.569), describes a global motion estimation based on a block motion estimation. It appeared that in theory, the earlier method yields quite a good global motion vector. In reality, however, this is not always the case.

It is, inter alia, an object of the invention to provide an improved global motion estimation. To this end, the invention provides a global motion estimation as defined in the independent claims. Advantageous embodiments are defined in the dependent claims.

The present invention is based on the following recognitions. In the earlier method, without explicitly saying so, it is assumed that the optical plane is matched perfectly to the image plane describing the motion field. In reality, this silent assumption does not hold true. Thru experimentation we have found that due to lens distortion (barrel aberration) the results can be quite unpredictable. It appeared that the lens distortion close to the image center is much less when compared to the image peripheral. A large image resolution with a wide field of view results in worse lens distortion. An image peripheral motion field produced by the prior art is not stable due to lens distortion and can incorrectly influence the global motion vector. Anyhow, the computational load of the prior art method is high when processing VGA resolution frames. To correct each frame to account for lens distortion (3rd order effect) prior to block motion estimation is computationally prohibitive. In accordance with a primary aspect of the present invention, global motion is processed with a centrally located portion of the image that is not too sensitive to lens distortion. In a preferred embodiment, the processing is carried out only for a quarter image around the image center. Tests have proven this simple technique to be quite effective and yielding good results. As an additional benefit, the computational load is reduced as well to one quarter.

These and other aspects of the invention will be apparent from and elucidated with reference to the embodiments described hereinafter.

In the drawings:

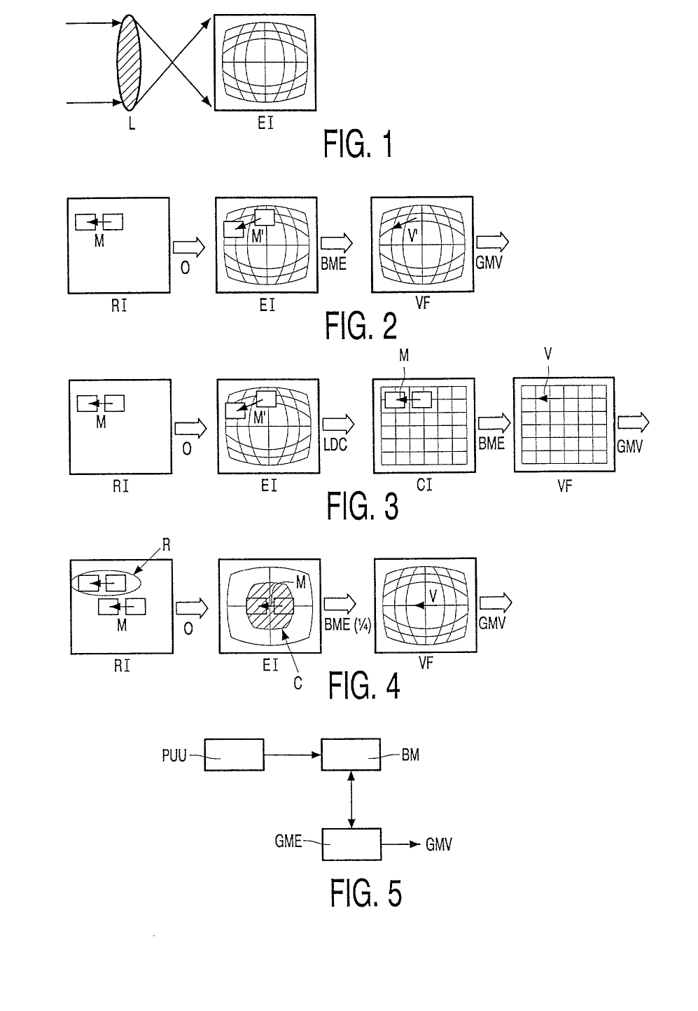

FIG. 1 shows how an image is transformed by a lens;

FIG. 2 shows how in the prior art a global motion vector is derived;

FIG. 3 shows how a better result could be obtained;

FIG. 4 shows an embodiment of a method according to the invention; and

FIG. 5 shows an embodiment of a camera according to the invention.

In FIG. 1, a real image is transformed by a lens L to obtain an electronic image EI. The lens distortion problem (commonly known as barrel aberration) is clearly shown.

As shown in FIG. 2, this leads to an incorrect global motion vector GMV. A real image RI in which motion M is present, is transformed by optics O into the electronic image EI. In the electronic image EI, the motion M′ no longer corresponds to the real motion M. Accordingly, in the vector field VF that is obtained by the block motion estimation BME, the motion vector V′ is incorrect, as is the resulting global motion vector GMV.

As shown in FIG. 3, this problem could be solved by a complex and computationally extremely expensive lens distortion correction LDC. In the corrected image CI, the correct motion M is present, so that in the resulting vector field VF, the correct vector V is present.

In the embodiment of FIG. 4, only a central part C of the image is taken into account. Motion outside this central part C is rejected (R). In the central part C, motion M is not distorted, so that in the vector field VF, the resulting vector V will be correct as will be the global motion vector GMV. In a preferred embodiment, only the central quarter of the image is taken into account.

FIG. 5 shows an embodiment of a camera in accordance with the present invention. An image pick-up unit PUU furnishes a video signal to a block matcher BM that interacts with e global motion estimator GME to produce the global motion vector GMV. Preferably, the method described in more detail in the earlier non-prepublished EP application No.: 99202532.0-2202, filed on Feb. 8. 1999 (attorneys' docket PHN 17.569), is used, with the characterizing feature that only a central part (e.g. <75%, preferably <50%, advantageously about ¼) of the image is used.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage. The invention is advantageously applied in scanner software for scanners using rather cheap lenses.

1. A method of estimating a global motion vector (GMV), the method comprising the steps of:
furnishing (O) an electronic image (EI); and
estimating (BM, GME) the global motion vector using only a central part (C) of the electronic image (EI), which central part (C) is substantially smaller than the electronic image (EI).

2. A method as claimed in claim 1, wherein the central part (C) is less than 75% of the electronic image (EI).

3. A method as claimed in claim 2, wherein the central part (C) is less than 50% of the electronic image (EI).

4. A method as claimed in claim 1, wherein the central part (C) substantially equals 25% of the electronic image (EI).

5. A device for estimating a global motion vector (GMV), the device comprising:
means for furnishing (O) an electronic image (EI); and
means for estimating (BM, GME) the global motion vector using only a central part (C) of the electronic image (EI), which central part (C) is substantially smaller than the electronic image (EI).

6. A camera, comprising:
an image pickup unit (PUU) for furnishing (O) an electronic image (EI); and
means for estimating (BM, GME) the global motion vector using only a central part (C) of the electronic image (EI), which central part (C) is substantially smaller than the electronic image (EI).
